(19) United States
(12) Patent Application Publication
(10) Pub. No.: US 2008/0312937 A1
(43) Pub. Date: Dec. 18, 2008

(54) Robotic Fighting System

(75) Inventor: Ching-Min Huang, Tainan County (TW)

Correspondence Address: CHING-MIN HUANG, 3F, NO. 5, ALLEY 47, LN. 76, JHONGSIAO RD.,, YONGKANG CITY, (R.O.C.), TAINAN COUNTY, 710, TW

(73) Assignee: Ching-Min Huang, Tainan County (TW)

(21) Appl. No.: 11/761,395

(22) Filed: Jun. 12, 2007

(51) Int. Cl. G06Q 99/00

(52) U.S. Cl. 705/1

(57) ABSTRACT

The patent is a new frame for the wars using robots instead of humans.

### BRIEF SUMMARY

The system consisted of several components that cooperate with others provides the requirements of the wars. The advantages of this system are automation, rapidness, and accuracy so it can deal with the various situations in the wars. Robots can change the form of the wars and become the leading role so that there will not be so many casualties any more.

### BACKGROUND

Since humans' civilization, wars never stop. Injuries and deaths are followed and unavoidable. If the form of the wars can be changed, it may reduce injuries and deaths. So, fighting by machines instead of humans is feasible. The system is a new frame that decreases casualties for the wars.

### DETAILED DESCRIPTION

### 1. Structure of the System

The system consists of coordinate robot, signal robot, attacking robot, supply robot, logistic supercomputer, coordinate device, identity device, and digital map. Each component is as follows.

Coordinate Robot

Coordinate robot is installed pantoscopic cameras with high multiple. Space coordinate of each moving object taken by pantoscopic cameras is calculated by logistic supercomputer at the synchronous time. The time lag of two moving coordinates can calculate its moving speed and coordinate, and also identify it as humans, animals or robots (types of the robots) for the signal robot to arrange the using of the army. With the wars situation, setting up coordinate device in the battlefield provides each robot to calculate the coordinates. It can replace the work of signal robot when insufficient.

Signal Robot

Signal robot is installed pantoscopic cameras with high multiple to calculate coordinate around itself. Signal robot, according to coordinate that coordinate robot offers, selects battle array and attacking tactics, observes the situation to change the array and tactics, and sends attacking robot to assault the enemy nearby. It can replace the work of coordinate robot when insufficient.

Attacking Robot

Attacking robot is installed pantoscopic cameras to calculate coordinate around itself and the enemy nearby with images from coordinate robot. Attacking robot can be divided into three types, near-distance attacking robot, distant attacking robot (the land to the land, the land to the air and the land to the sea) and casting attacking robot by its use of weapons. It calculates the relative coordinate of attacking robot, which is moving coordinate of each component, to attack the enemy that signal robot selects, and avoids the possibilities of its own robots to be attacked by itself.

Supply Robot

Supply robot is installed pantoscopic cameras to calculate coordinate around itself. More than one soldier operates the robot for the change of its power devices, damaged parts, supply of the ammunition, and retrieve of coordinate devices. According to the situation, soldiers can change communications channels of all robots, coordinate devices and identity device to avoid being usurped or controlled by the enemy. The power of each robot can be switched off and restarted itself (against electromagnetic pulse attack). Soldiers can deny the result of the calculation from signal robot to command the army to change the array and attacking tactics, to pursue or to retreat.

Logistic Supercomputer

Logistic supercomputer built underground processes the calculating procedure of each robot to assist the army at the battlefront on calculation. When logistic supercomputer is damaged, its management system is transformed from centralized control into distributed computing. Data transmitting should be encrypted and communications channels should be changed aperiodically to avoid the enemy from controlling.

Coordinate Device

Coordinate device is the coordinate as referral for every robot in the battle so that the absolute coordinate calculation can be transformed into the relative coordinate calculation. When the device is installed, the space coordinate is calculated by coordinate robot for adjustment. The coordinate of the effective area is calculated by coordinate device for each robot.

Identity Device

Identity device can distinguish the enemy from its own army. It is installed in each robot, soldier and the army. It malfunctions when robots are damaged or soldiers dead.

Digital Map

Digital map is obtained through aerial survey, satellite or sophisticated equipment. It is installed in each robot to calculate the relative position and space coordinate in all objects.

### 2. Operation of the System

The calculation procedure of each robot is processed by logistic supercomputer. Coordinate robot, airplanes and satellite provide the coordinate for short and long distance, which assists signal robot to select the tactics and allocate work to attacking robot. Supply robot follows in back of the array to supply the weaponry and the ammunition. The use of coordinate device remarkably reduces calculation load of the coordinate, while identity device makes clear to distinguish the enemy from its own army. Before the battle, digital map is obtained through aerial survey, satellite or sophisticated equipment for evaluation of the use of the tactics.

1. The inventor gets a 2% royalty.

2. The users endow a 6% royalty to medical, environmental, and charity organizations with anonymity; if contributors disclose themselves to the public, the subscription is invalid.

3. If anyone modifies this system to apply a patent, he/she shall endow a 6% royalty to medical, environmental, and charity organizations with anonymity.
